(19) United States
(12) Patent Application Publication
(10) Pub. No.: US 2004/0225734 A1
(43) Pub. Date: Nov. 11, 2004

(54) Method and system to control the communication of data between a plurality of inteconnect devices

(76) Inventors: Richard L. Schober, Cupertino, CA (US); Rick Reeve, San Francisco, CA (US); Prasad Vajjhala, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/431,975

(22) Filed: May 7, 2003

(51) Int. Cl. G06F 15/173; G06F 15/16

(52) U.S. Cl. 709/225; 709/229

(57) ABSTRACT

A method and system of communicating data between a plurality of interconnect devices are described. The method includes allocating a sequence number associated with each grant authorizing a source interconnect device to communicate the data to a destination interconnect device. The sequence number of a queued grant is then with a reference sequence number and, in response to the comparison, the data is communicated. In one embodiment, the sequence number is a grant sequence number that defines a sequence in which each grant is to be executed in response to a comparison with a reference transmit sequence number.

### FIELD OF THE INVENTION

The present invention relates generally to the field of data communications and, more specifically, to a method and system of communicating data between a plurality of interconnect devices in a communications network.

### BACKGROUND OF THE INVENTION

Existing networking and interconnect technologies have failed to keep pace with the development of computer systems, resulting in increased burdens being imposed upon data servers, application processing and enterprise computing. This problem has been exacerbated by the popular success of the Internet. A number of computing technologies implemented to meet computing demands (e.g., clustering, fail-safe and 24×7 availability) require increased capacity to move data between processing nodes (e.g., servers), as well as within a processing node between, for example, a Central Processing Unit (CPU) and Input/Output (I/O) devices.

With a view to meeting the above described challenges, a new interconnect technology, called the InfiniBand™, has been proposed for interconnecting processing nodes and I/O nodes to form a System Area Network (SAN). This architecture has been designed to be independent of a host Operating System (OS) and processor platform. The InfiniBand™ Architecture (IBA) is centered around a point-to-point, switched IP fabric whereby end node devices (e.g., inexpensive I/O devices such as a single chip SCSI or Ethernet adapter, or a complex computer system) may be interconnected utilizing a cascade of switch devices. The IBA supports a range of applications ranging from back plane interconnect of a single host, to complex system area networks, as illustrated in FIG. 1 (prior art). In a single host environment, each IBA switched fabric may serve as a private I/O interconnect for the host providing connectivity between a CPU and a number of I/O modules. When deployed to support a complex system area network, multiple IBA switched fabrics may be utilized to interconnect numerous hosts and various I/O units.

Within a switch fabric supporting a System Area Network, such as that shown in FIG. 1, there may be a number of devices having multiple input and output ports through which data (e.g., packets) is directed from a source to a destination. Such devices include, for example, switches, routers, repeaters and adapters (exemplary interconnect devices). Where data is processed through a device, it will be appreciated that multiple data transmission requests may compete for resources of the device. For example, where a switching device has multiple input ports and output ports coupled by a crossbar, packets received at multiple input ports of the switching device, and requiring direction to specific outputs ports of the switching device, compete for at least input, output and crossbar resources.

In order to facilitate multiple demands on device resources, an arbitration scheme may be employed to arbitrate between competing requests for device resources. Such arbitration schemes are typically either (1) distributed arbitration schemes, whereby the arbitration process is distributed among multiple nodes, associated with respective resources, through the device or (2) centralized arbitration schemes whereby arbitration requests for all resources are handled at a central arbiter. An arbitration scheme may further employ one of a number of arbitration policies, including a round robin policy, a first-come-first-served policy, a shortest message first policy or a priority based policy, to name but a few. The physical properties of the IBA interconnect technology have been designed to support both module-to-module (board) interconnects (e.g., computer systems that support I/O module add in slots) and chasis-to-chasis interconnects, as to provide to interconnect computer systems, external storage systems, external LAN/WAN access devices. For example, an IBA switch may be employed as interconnect technology within the chassis of a computer system to facilitate communications between devices that constitute the computer system. Similarly, an IBA switched fabric may be employed within a switch, or router, to facilitate network communications between network systems (e.g., processor nodes, storage subsystems, etc.). To this end, FIG. 1 illustrates an exemplary System Area Network (SAN), as provided in the InfiniBand™ Architecture Specification, showing the interconnection of processor nodes and I/O nodes utilizing the IBA switched fabric. It is however to be appreciated that IBA is merely provided as an example to illustrate an application of the invention.

### SUMMARY OF THE INVENTION

In accordance with one aspect of the invention, there is provided a method of communicating data between a plurality of interconnect devices, the method including:

allocating a sequence number associated with each grant authorizing a source interconnect device to communicate the data to a destination interconnect device;

comparing the sequence number of a queued grant with a reference sequence number; and

communicating the data in response to the comparison.

Further in accordance with the invention, there is provided a method of controlling the communication of data from an interconnect device, the method including:

receiving a grant authorizing the communication of the data;

extracting a grant sequence number from the grant;

comparing the grant sequence number with a reference transmit sequence number; and

communicating the data in response to the comparison.

In accordance with a yet further aspect of the invention, there is provided method of managing the execution of grants issued to a plurality of interconnect devices, the method including:

receiving a grant request from an interconnect device to communicate data to a destination interface device;

selectively allocating a grant sequence number to the grant, the grant sequence number defining when the grant is to be executed; and

communicating the grant sequence number to the interconnect device.

The invention extends to a machine-readable medium embodying a sequence of instructions that, when executed by a machine, cause the machine to execute any of the methods described herein.

In accordance with a further aspect of the invention, there is provided a system for communicating data between a plurality of interconnect devices, the system including:

an arbiter to allocate a sequence number associated with each grant authorizing a source interconnect device to communicate the data to a destination interconnect device;

a comparator to compare the sequence number of a queued grant with a reference sequence number; and

a data transmission module to communicate the data in response to the comparison.

According to a yet further aspect of the invention, there is provided an interconnect device, which includes:

a grant module to receive a grant authorizing the communication of data received by the interconnect to an associated interconnect device;

a processor to extract a grant sequence number from the grant and to compare the grant sequence number with a reference transmit sequence number; and

a data transmission module to communicate the data in response to the comparison.

According to a yet still further aspect of the invention, there is provided an arbiter for managing the execution of grants issued to a plurality of interconnect devices, the arbiter including a grant allocator:

to receive a grant request from an interconnect device to communicate data to a destination interface device;

to selectively allocate a grant sequence number to the grant that defines when the grant is to be executed; and

to communicate the grant sequence number to the interconnect device.

Other features of the present invention will be apparent from the accompanying drawings and from the detailed description that follows.

### BRIEF DESCRIPTION OF THE DRAWINGS

The present invention is illustrated by way of example, and not limitation, in the figures of the accompanying drawings, in which like references indicate the same or similar features.

In the drawings,

FIG. 1 shows a diagrammatic representation of a System Area Network, according to the prior art, as supported by a switch fabric;

FIGS. 2A and 2B show a diagrammatic representation of a data path, according to an exemplary embodiment of the present invention, implemented within an interconnect device (e.g., a switch);

FIG. 3 shows a diagrammatic representation of a communication port, according to an exemplary embodiment of the present invention, which may be employed within a data path;

FIG. 4 shows a diagrammatic representation of an arbiter, according to an exemplary embodiment of the present invention;

FIGS. 5A and 5B show an exemplary grant issued by the arbiter of FIG. 4;

FIG. 6 shows a diagrammatic representation of certain components included in the port of FIG. 3;

FIG. 7 shows a diagrammatic representation of an interconnection arrangement of incoming increment lines and outgoing increment lines for incrementing a grant sequence count, in accordance with an exemplary embodiment of the invention;

FIG. 8 shows a diagrammatic representation of transmit sequence number counters and pre-fetch sequence number counters, according to an exemplary embodiment of the invention;

FIGS. 9A and 9B show a schematic flow diagrams of a method, according to an exemplary embodiment of the present invention, for communicating data packets between a plurality of interconnect devices;

FIG. 10 shows a schematic flow diagram of a method, according to an exemplary embodiment of the present invention, for generating grants at an arbiter;

FIG. 11 shows exemplary timing signals associated with the transmit sequence numbers;

FIG. 12 shows a schematic flow diagram of method, in accordance with an exemplary embodiment of the present invention, for pre-fetching a data packet for subsequent transmission; and

FIG. 13 shows exemplary timing signals associated with the pre-fetch sequence numbers.

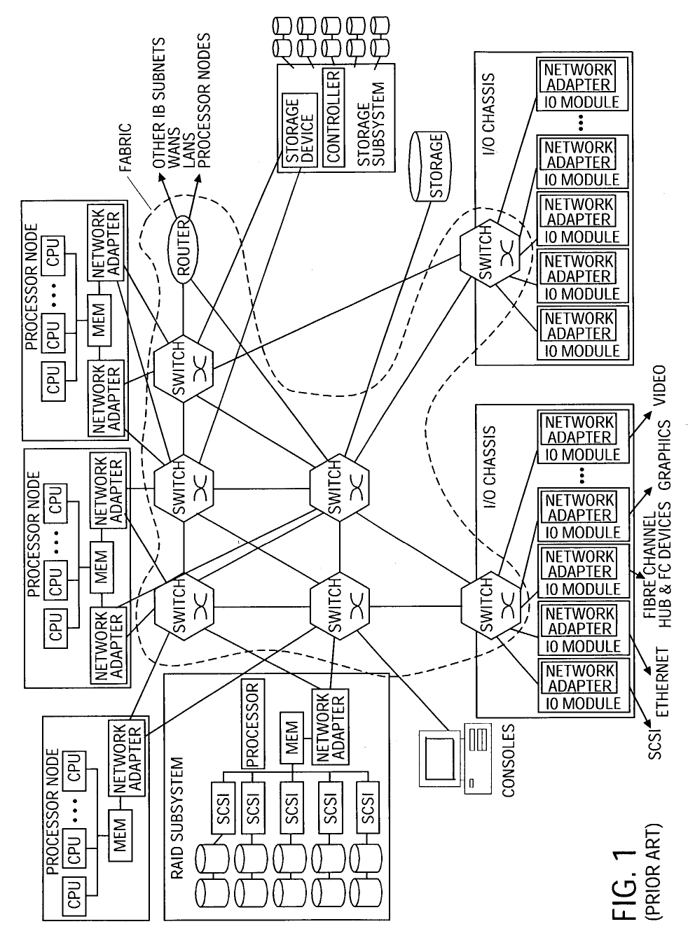

### DETAILED DESCRIPTION

A method and system to communicate data between a plurality of interconnect devices are described. In the following description, for purposes of explanation, numerous specific details are set forth in order to provide a thorough understanding of the present invention. It will be evident, however, to one skilled in the art that the present invention may be practiced without these specific details.

For the purposes of the present invention, the term “interconnect device” shall be taken to include switches, routers, repeaters, adapters, or any other device that provides interconnect functionality between nodes. Such interconnect functionality may be, for example, module-to-module or chassis-to-chassis interconnect functionality. While an exemplary embodiment of the present invention is described below as being implemented within a switch deployed within an InfiniBand™ architectured system, the teachings of the present invention may be applied to any interconnect device within any interconnect architecture.

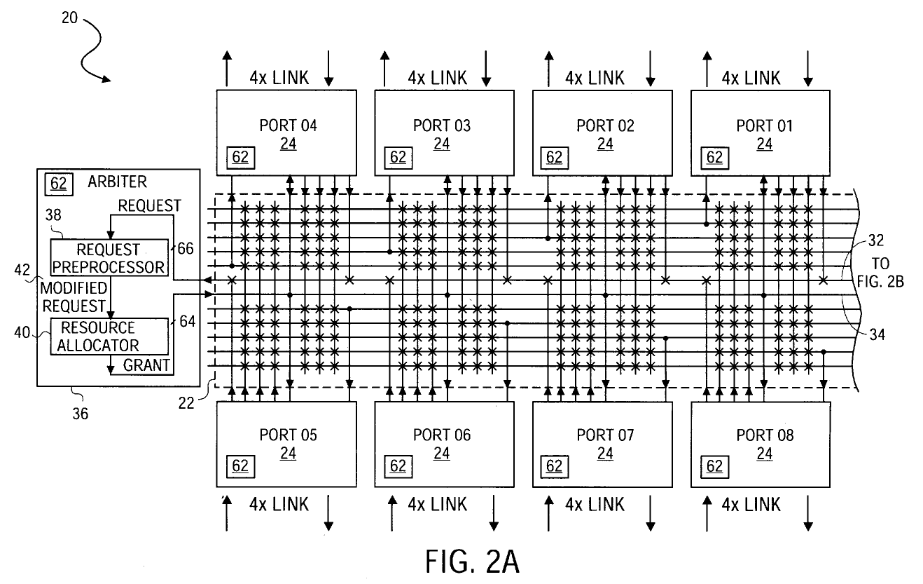

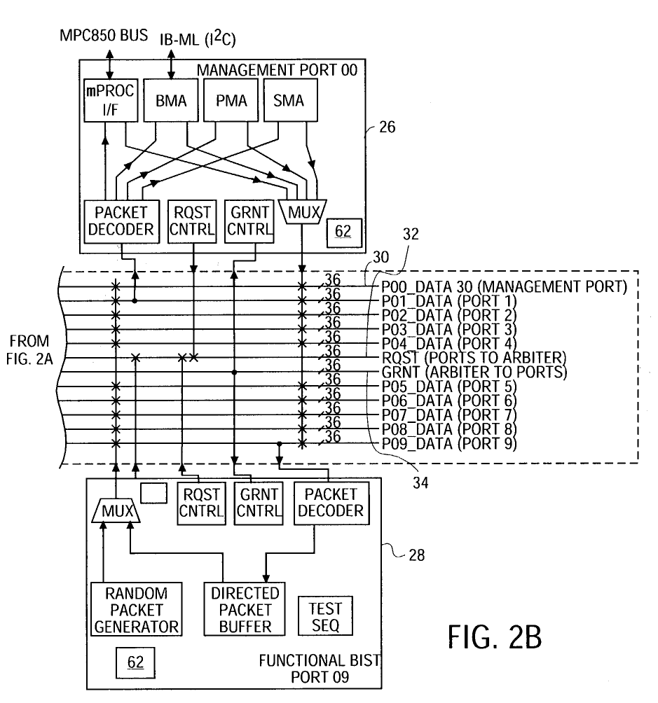

Referring to the drawings, FIGS. 2A and 2B provide a diagrammatic representation of a datapath 20, according to an exemplary embodiment of the present invention, implemented within an interconnect device (e.g., a switch). The datapath 20 is shown to include a crossbar 22 connected to I/O ports 24, a management port 26, and a Built-In-Self-Test (BIST) port 28. The crossbar 22 includes data buses 30, a request bus 32 and a grant bus 34. In the exemplary embodiment, coupled to the crossbar are eight communication ports 24 that issue resource requests to an arbiter 36 via the request bus 32, and that receive resource grants from the arbiter 36 via the grant bus 34. In addition, the management port 26 and the functional BIST port 28 also send requests to, and receive grants from, the arbiter 36.

The arbiter 36 includes a request preprocessor 38 and a resource allocator 40. The preprocessor 38 receives resource requests from the request bus 32 and generates a modified resource request 42 which is sent to the resource allocator 40. The resource allocator 40 then issues a resource grant on the grant bus 34. In certain embodiments, the resource grant includes a grant sequence number which controls a grant delivery order, a packet pre-fetch sequence/order and a packet transmission order of the grant and associated packet in relation to other packets being sent through the same output (target) port 24. As described in more detail below, sequencing of packets through different output ports 24 may be independent.

In addition to the eight communication ports 24, the management port 26 and the functional BIST port 28 are also coupled to the crossbar 22. The management port 26 may, for example, include a Sub-Network Management Agent (SMA) that is responsible for network configuration, a Performance Management Agent (PMA) that maintains error and performance counters, a Baseboard Management Agent (BMA) that monitors environmental controls and status, and a microprocessor interface.

In one embodiment, the functional BIST port 28 supports stand-alone, at-speed testing of an interconnect device of the datapath 20. The functional BIST port 28 may include a random packet generator, a directed packet buffer and a return packet checker.

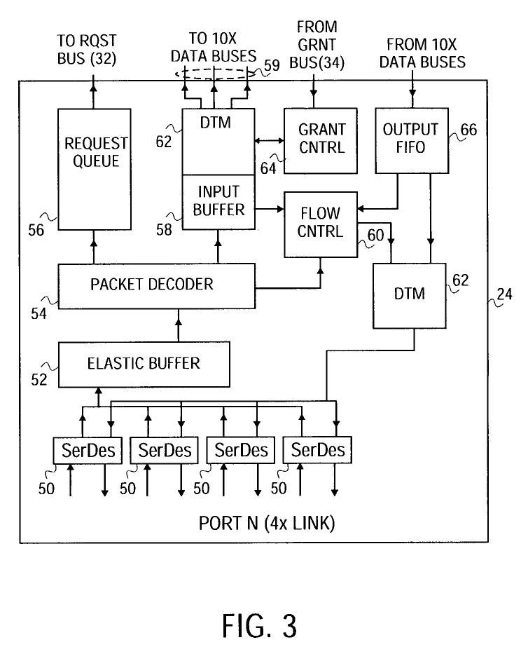

Turning now to the communication ports 24, FIG. 3 is a block diagram providing architectural details of an exemplary comminication port 24 as may be implemented within the datapath 20. While the datapath 20 of FIGS. 2A and 2B is shown to include eight 4×duplex communication ports 24, the present invention is not limited to such a configuration. Each comminication port 24 is shown to include four Serializer-Deserializer circuits (SerDes) 50 via which 32-bit words are received at, and transmitted from, the port 24. Each SerDes 50 operates to convert a serial, coded (e.g. 8B10B) data bit stream into parallel byte streams, which include data and control symbols. In one embodiment, data received via the SerDes 50 at the port 24 is communicated as a 32-bit word to an elastic buffer 52.

From the elastic buffer 52, packets are communicated to the packet decoder 54 that generates a request, associated with a packet, which is placed in a request queue 56 for communication to the arbiter 36 via the request bus 32. In the exemplary embodiment of the present invention, the types of requests generated by the packet decoder 54 for inclusion within the request queue 56 include packet transfer requests and credit update requests.

Each comminication port 24 is also shown to include an input buffer 58, the capacity of which is divided equally among data virtual lanes (VLs) supported by the datapath 20. Virtual lanes are, in one embodiment, independent data streams that are supported by a common physical link. Further details regarding the concept of “virtual lanes” is provided in the InfiniBand™ Architecture Specification, Volume 1, Release 1.1, Nov. 6, 2002.

In one embodiment, the input buffer 58 of each port 24 is organized into 64-byte blocks, and a packet may occupy any arbitrary set of buffer blocks. Link lists keep track of packets and free blocks within the input buffer 58. Each input buffer 58 is also shown to have three read port-crossbar inputs 59.

A flow controller 60 monitors the amount of incoming and outgoing packet data, keeps track of the free input buffer space for each virtual lane, and exchanges information regarding available input buffer space with a neighbor device at an opposed end of the external physical link. Further details regarding an exemplary credit-based flow control are provided in the InfiniBand™ Architecture Specification, Volume 1.

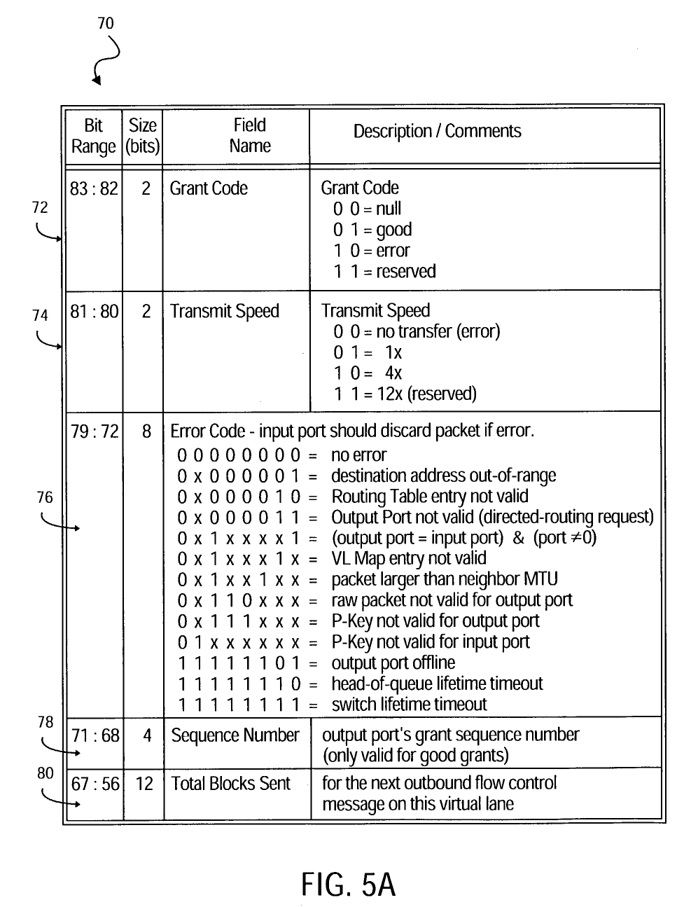

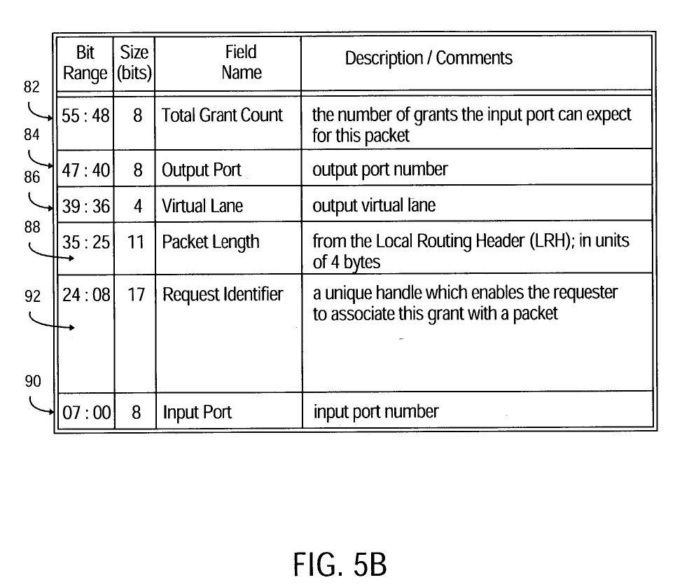

The comminication port 24 also includes a grant controller 64 to receive resource grants 70 (see FIG. 5) from the arbiter 36 via the grant bus 34.

In certain embodiments, a routing request sent by a port 24 includes, a request code identifying the request type, an input port identifier that identifies the particular port 24 from which the request was issued, a request identifier or “handle” that allows the grant controller 64 of a port 24 to associate a grant received from the arbiter 36 with a specific packet. For example, the request identifier may be a pointer to a location within the input buffer 58 of the particular comminication port 24. The request identifier is necessary as a particular port 24 may have a number of outstanding requests that may be granted by the arbiter 36 in any order.

A packet length identifier provides information to the arbiter 36 regarding the length of a packet associated with a request. An output port identifier of the direct routing request identifies a comminication port 24 (a destination or output port) to which the relevant packets should be directed. In lieu of an output port identifier, the destination routing request includes a destination address and a partition key. A destination routing request may also include a service level identifier, and a request extension identifier that identifies special checking or handling that should be applied to the relevant destination routing request. For example, the request extension identifier may identify that an associated packet is a subnet management packet (VL15), a raw (e.g., non-InfiniBand™) packet, or a standard packet where the partition key is valid/invalid.

A credit update request may be provided that includes a port status identifier that indicates whether an associated port 24, identified by the port identifier, is online and, if so, the link width (e.g., 12×, 4× or 1×). Each credit update request also includes a virtual lane identifier and a flow control credit limit.

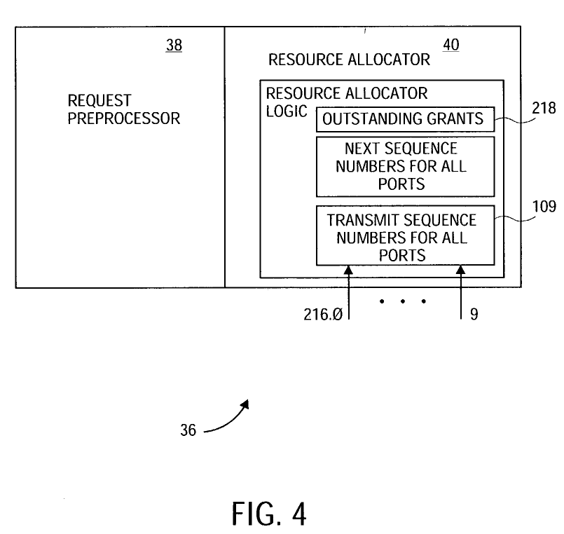

FIG. 4 is a conceptual block diagram of the arbiter 36, according to an exemplary embodiment of the present invention. The arbiter 36 is shown to include the request preprocessor 38 and the resource allocator 40. As discussed above, the arbiter 36 implements a central arbitration scheme within the datapath 20, in that all requests and resource information are brought to a single location (the arbiter 36). It should however be noted that the present invention may also be deployed within a distributed arbitration scheme, wherein decision making is performed at local resource points to deliver potentially lower latencies and higher throughput.

The arbiter 36, in the exemplary embodiment, implements serial arbitration in that one new request is accepted per cycle, and one grant is issued per cycle. Again, in deployments where the average packet arrival rate is greater than one packet per clock cycle, the teachings of the present invention may be employed within an arbiter that implements parallel arbitration.

Dealing first with the request preprocessor 38, a request (e.g., a destination routing, direct routing or credit update request) is received on the request bus 32. A packet's destination address is utilized to perform a lookup on both unicast and multicast routing tables. If the destination address is for a unicast address, the destination address is translated to an output port number. On the other hand, if the destination is for a multicast group, a multicast processor spawns multiple unicast requests based on a lookup in the multicast routing table.

In one embodiment, when a packet transfer request reaches the resource allocator 40, it specifies an input port 24, an ouput port 24 through which the packet is to exit the switch, the virtual lane on which the packet is to exit, and the length of the packet. If, and when, the path from the input port 24 to the output port 24 is available, and there are sufficient credits from the downstream device, the resource allocator 40 will issue a grant. If multiple requests are targeting the same port 24, the resource allocator 40 uses an arbitration protocol described in the Infiniband Architecture Specification.

As mentioned above, the arbiter 36, in response to each request from the I/O ports 24, the management port 26, and the functional BIST port 28, which thus define input or source ports, issues a grant 70 in the exemplary format shown in FIG. 5. In certain embodiments, the arbiter 36 issues just-in-time grants and advance grants.

Just-in-time grants may timed by the arbiter 36 so that the requester (e.g. an input port 24) can immediately start transmitting a packet to a target output port 24 as soon as it receives an associated grant. The arbiter 36 ensures that there is no overlap between sequential packet transfers. In one embodiment, the arbiter 36 does this by looking at a packet length and transfer rate to determine the duration of a packet transfer. Knowing the packet transfer time, the arbiter 36 may anticipate its completion and issue another grant just in time both to avoid packet collisions and to avoid gaps between packets. Just-in-time grant may work satisfactorily when a time between the issuance of a grant by the arbiter 36, and the start of the packet transfer by an input port 24 is predictable.

Advance grants may be issued well in advance of when packet transmission by a port 24 may begin. Situations can arise in which multiple grants can be outstanding as only one packet transfer can occur at a time. In the case of advance grants, it may be up to the recipients to synchronize their transfers to any given output port 24 so as to avoid collisions and minimize gaps between packets. Transmit sequence numbers, which are assigned by the arbiter 36, specify the packet transmission order for each output port 24. As described in more detail below, in one embodiment the transmit sequence numbers are used by the input ports 24 to synchronize their transmissions to one or more output ports 24. Advance grants may work satisfactorily when the time between the issuance of a grant by the arbiter 36, and the start of the packet transfer by an input port 24 is unpredictable.

The grant 70 communicated from the arbiter 36 to the ports 24, 26, 28 include a two bit grant code provided in a grant code field 72. In the exemplary embodiment, a “00” code indicates that the request from the requesting input port 24 has not been granted by the arbiter 36, and a code “01” indicates that the request has been granted. A code “10” indicates that there has been an error during the request for a grant and, accordingly, the requesting input port 24 should discard the packet. A code “11” may be reserved for another use.

In addition to the grant code, the grant 70 also includes a two bit transmit speed provided in the transmit speed field 74. For good grants, the transmit speed may match the operating speed of an output link. As discussed below, under certain error conditions (e.g. DLID translation fails or the output port 24 is offline), the output link speed may be unknown. In these circumstances in one embodiment, the transmit speed is set to the input port's link speed. If the input port's link speed is unknown (e.g. the link goes down after receiving a packet), the transmit speed may be set to lx.

The grant 70 also includes an eight bit error code provided in an error code field 76. The error code indicates that the requesting input port 24 should discard the data packet, for example, if there has been an error such as, the destination address is out of range, the routing table entry is not valid, the output or destination port 24 is not valid, the output port 24 equals the input port 24, a VL map entry is not valid, the packet is larger than the neighbor MTU, a raw packet is not valid for an output port 24, a P-Key is not valid for an output port 24, a P-Key is not valid for an input port 24, an output port 24 is offline, a head-of-queue lifetime time out has occurred, a switch lifetime time out has occurred, or the like. It is to be appreciated that, using the eight bits in the error code, various different codes may be defined dependent upon the application of the invention.

In one embodiment, the grant 70 also includes a four bit grant sequence number provided in a grant sequence number field 78. Each grant sequence number is associated with a particular port 24 when the port 24 functions as an output port receiving packets from any of its neighboring input ports 24. As the grant sequence numbers define the sequence in which packets are sent to each port 24, when functioning as an output port, they are used by all other ports 24 to time when a particular input port 24 may send its data packet to the output port 24 associated with the particular sequence of grant sequence numbers. Thus, a sequence of grant sequence numbers may be provided for each particular port 24 to control the communication of packets from other ports 24 to the particular port 24. A grant sequence number is only generated for good grants (grant code “01”). As will be described in more detail below, the arbiter 36 generates the grant sequence number when granting a service request received from any one of the ports 24 to communicate a data packet to a destination or output port 24.

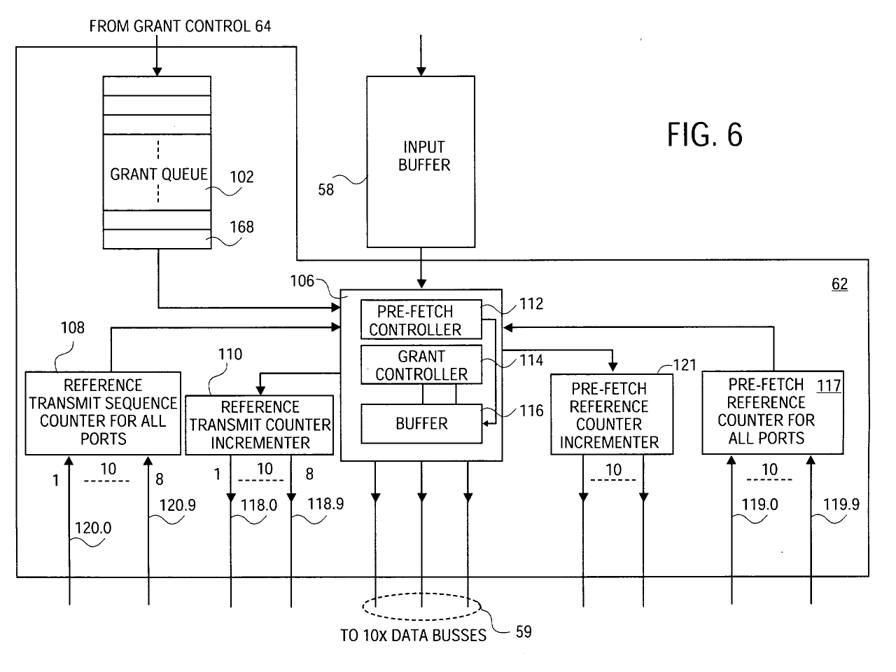

Returning to the grant 70, a twelve bit total blocks sent field 80 is provided to identify the total number of blocks sent for a next outbound flow control message on a particular virtual lane. The grant 70 also includes an eight bit total grant count in a grant count field 82 which defines the number of grants an input port 24 can expect for a particular data packet, an eight bit output port field 84 which includes a output port number identifying the particular port 24 that the data package is to be communicated to from an input port 24, a four bit virtual lane field 86 to identify an output virtual lane, an eleven bit packet length field 88 including packet information sourced from the local routing header, and an eight bit input port field 90 to identify an input port number from which a request has been received. In addition, the grant 70 includes a seventeen bit request identifier field 92 providing a unique handle which enables the requesting port 24 to associate a particular grant 70 with a data packet that the port 24 requested the grant for. In certain embodiments, the request identifier field 92 is a pointer to a start of the packet in an input buffer 58 (see FIG. 6) of the port 24.

In one embodiment, the grant sequence number issued by the arbiter 36, as mentioned above, is a four bit number thus providing a sequence of sixteen grant sequence numbers which are associated with a particular output port 24 to which packets are to be sent from the other ports 24 of the datapath 20. As described in more detail below, the arbiter 36 includes a counter (for each particular port 24) which is incremented each time a grant is issued that authorizes another port 24 to communicate a data packet across the crossbar 22 to the particular port 24 associated with the counter.

Thus, a grant sequence number in the grant sequence number field 78 identifies when a grant 70 to an input port 24, can be executed.

As will be described in more detail below, the grant sequence number may be used by a plurality of input ports 24 to identify when a particular input port 24 is to send its packet to a destination or output port 24.

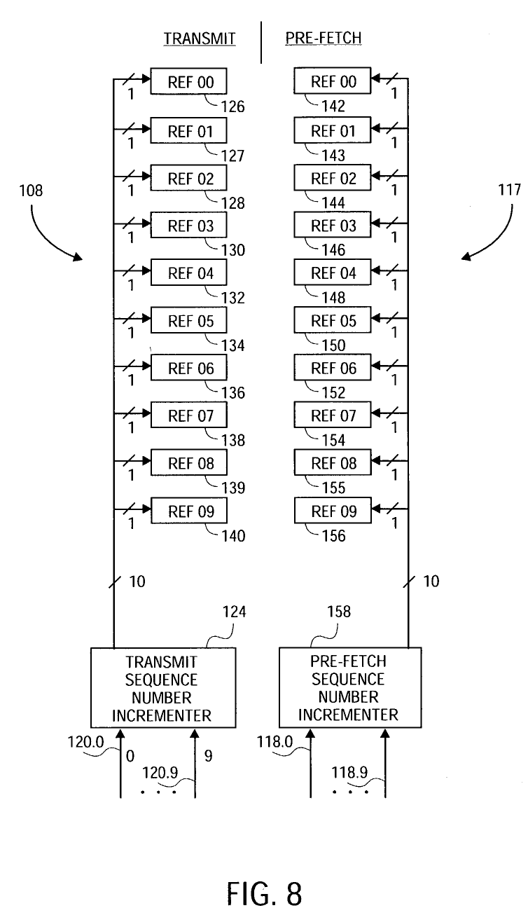

A transmit sequence number may be provided which identifies the next packet to be transmitted to the port 24. The transmit sequence number may thus identify the next packet by looking at its associated grant sequence number. By way of example, assume that ports 05, 06, 07 and 08 (see FIG. 2) are to communicate packets to port 01. When ports 05, 06, 07 and 08 request a grant from the arbiter 36, the arbiter 36 includes a unique grant sequence number in each grant to each of the ports 05, 06, 07 and 08 that defines the order in which the ports 05, 06, 07 and 08 communicate or transmit their packets to the port 01 in order to avoid conflicts on the crossbar 22. In order to communicate a packet dependent upon a particular grant sequence number, each port includes an exemplary data transmission module 62 (see FIGS. 2, 3 and 6). The data transmission module 62 includes a grant queue 102, a grant and pre-fetch controller 106, a reference transmit sequence counter 108 (see also FIG. 8), and a reference transmit counter incrementer 110 (see FIG. 6). When a grant 70 is received by a requesting port 24 it is then placed in the grant queue 102 of the data transmission module 62. In order to identify when a packet associated with the particular grant 70 is to be communicated to the output port 24, the data transmission module 62 includes the reference transmit sequence counter 108. In particular, the reference transmit sequence counter 108 includes, for the particular embodiment depicted in the drawings, ten counters namely a counter for the eight ports 24, a counter for the management port 26, and a counter for the functional BIST port 28 (see FIG. 8). The reference transmit sequence counter 108 for each particular port 24, 26, 28 identifies the next grant 70 to be executed or the grant currently being executed. Accordingly, the reference transmit sequence counter 108 identifies the next packet that is to be communicated from the input port 24 to the output port 24 or the packet that is currently being communicated.

The grant and pre-fetch controller 106 (see FIG. 6) includes a pre-fetch controller 112, a grant controller 114, and a pre-fetch buffer 116. As described in more detail below, the pre-fetch controller 112 anticipates the time when the package is to be transmitted over the crossbar 22 and, in advance, fetches the appropriate packet from the input buffer 58. Thereafter, the grant controller 114, in an anticipatory fashion, obtains the next grant 168 in the grant queue 102 and, thereafter, obtains the transmit sequence number or count for the particular output port 24 identified by the grant 70. When the transmit sequence number matches or equals the grant sequence number of the grant 70, the data transmission module 62 transmits the packet from the pre-fetch buffer 116 to the crossbar 22.

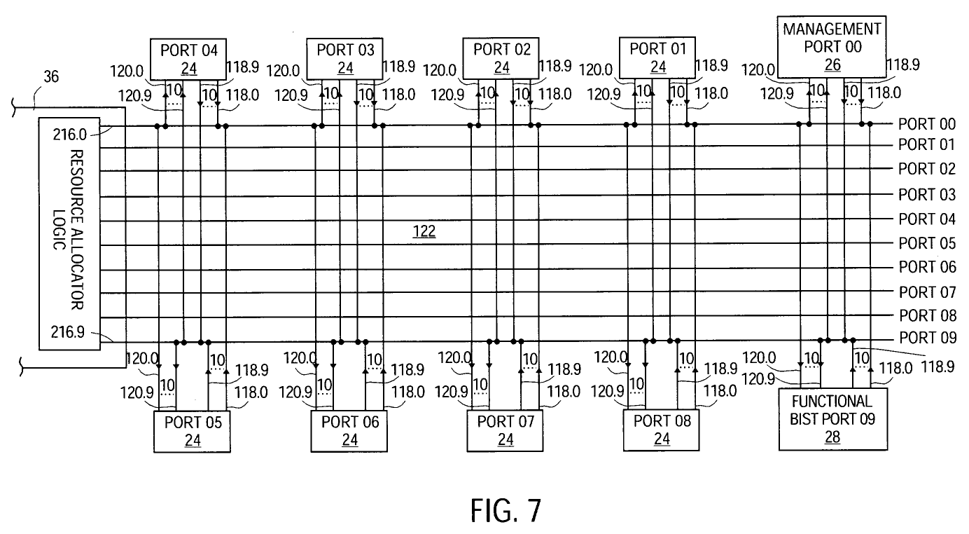

While the particular grant is being executed, the port 24 sending the packet, and thus executing the grant 70, increments the transmit sequence number stored in all other ports 24 using the reference transmit counter incrementer 110 and the outgoing increment lines 118.0 to 118.9. Each port 24, 26, 28 has ten outgoing increment lines 118.0 to 118.9 for incrementing each one of the ten reference transmit counters (see reference transmit counter 108 in FIG. 6) when the particular port 24 communicates a packet to the destination port 24 across the crossbar 22. In a similar fashion, each port 24 includes ten incoming increment lines 120.0 to 120.9 connected to the outgoing increment lines 118.0 to 118.9 by an increment grid 122 as shown in FIG. 7. In addition to updating or incrementing the reference transmit sequence counters 108 in each port, the transmit sequence counter 109 of the arbiter 36 is also updated (see FIG. 4).

FIG. 8 shows an exemplary representation of the arrangement of the reference transmit sequence counters 108 included in the ports 24, 26, 28 and the transmit sequence number module 109 of the arbiter 36. A transmit sequence incrementer component 124, in response to a transition on the incoming increment lines 120.0 to 120.9, increments an associated reference transmit counter in the port 24. For example, a reference transmit sequence counter 126 may be associated with the output port 00 and, when the incoming increment line 120.0 of the increment grid 122 is activated, the reference incrementer component 124 increments the reference transmit sequence counter 126. Likewise, reference transmit sequence counters 127 to 140 are associated with ports 01 to 09 respectively.

As mentioned above, the reference transmit sequence counters 126 to 140 are used to control the transmission of packets when the particular port 24, 26, 28 acts as an output port. Thus, for example, with reference to reference transmit sequence counter 126, the reference transmit sequence counter 126 identifies the grant 70 which is to be executed at any one of the ports 01 to 09 when they are waiting to send a packet to the port 00. Thus, in one embodiment, the reference transmit sequence counter 126 in each of the ports 01 to 09 controls the sequence in which the ports 01 to 09 communicate packets to the destination port 00. In a similar fashion and as described in more detail below, each port 24, 26, 28 includes reference pre-fetch sequence counters 142 to 156 (see FIG. 8) which control the pre-fetching of packets from the input buffer 58 into the pre-fetch buffer 116 (see FIG. 6). Thus, a pre-fetch incrementer 158 (see FIG. 8) is provided which, in certain embodiments, functions in substantially the same way as the transmit sequence number incrementer component 124.

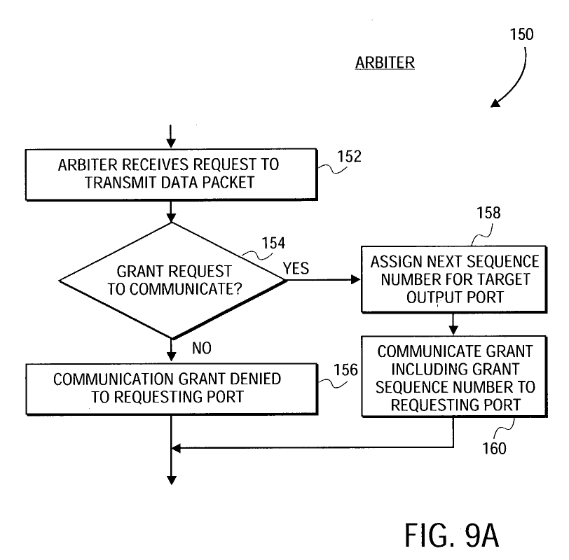

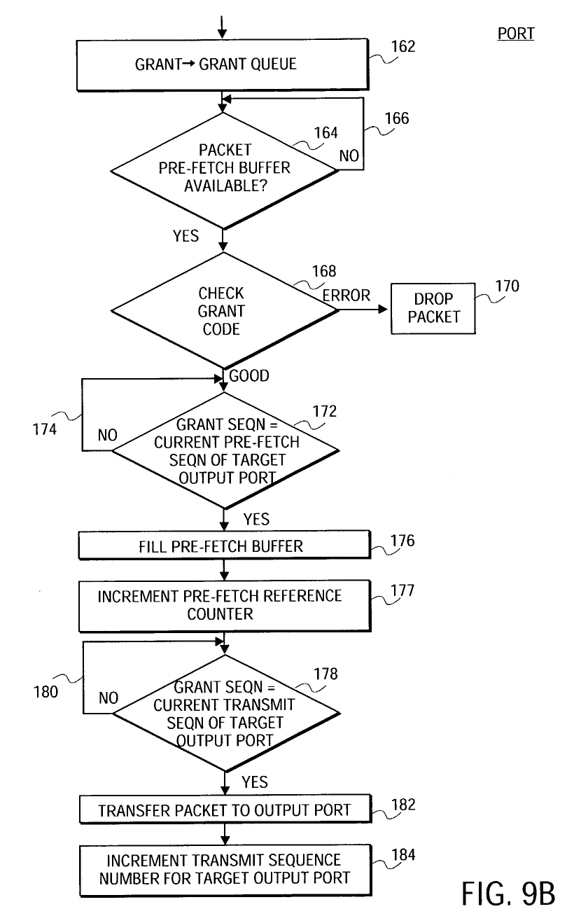

Referring in particular to FIG. 9, reference numeral 150 generally indicates an exemplary method, in accordance with a further aspect of the invention, of communicating packets between a plurality of interconnect devices such as the exemplary ports 24. As mentioned above, when any one of the ports 24 receives a packet for communication to another port 24, it sends a request to the arbiter 36. As shown at block 152, the arbiter 36 receives the request and, based on allocation logic, either authorizes or refuses the request as shown at decision block 154. If the arbiter 36 does not authorize the request from the port 24, which thus defines an input port 24, to transmit its package to another port 24, defining an output port 24, then the arbiter 36 issues a grant 70 including a grant code “10” (error) in the grant code field 72. Thus, as shown at block 156, a grant denied is effectively communicated to the particular port 24 requesting the authorization to communicate the packet.

Returning to decision block 154, if the arbiter 36 authorizes the particular input port 24 to communicate the packet to the output port 24, a grant code “01” (good) is provided in the grant code field 72 of the grant 70, a transmission speed identifier is provided in the transmission speed field 74, and a grant sequence number is generated and included in the grant sequence field 78 of the grant 70. The grant sequence number is one of a sequence of numbers generated by the arbiter 36 and is uniquely associated with a particular output port 24 as shown at block 158. The arbiter 36 also includes a total grant count in the total grant count field 82, identifies the output port 24 in the output port field 84, defines the virtual lane in the virtual lane field 86, defines the packet length in the packet length field 88, provides a unique request identifier in the request identifier field 92 so that the requesting port 24 can associate the particular grant 70 with a packet for which it requested the grant 70, and defines the input port in the input port field 90.

Once the arbiter 36 has built the grant 70, it is then communicated to the particular input port 24 requesting the packet transfer as shown at block 160. When the requesting port 24 receives the grant 70, it is placed in the grant queue 102 (see FIG. 6), as shown at decision block 162 in FIG. 9B. Thereafter, as shown at decision block 164, a check is performed to see if a packet pre-fetch buffer is available and, if not, a loop is entered into as shown by line 166. If, however, the pre-fetch buffer is available, the grant code is checked as shown at decision block 168. If the grant code indicates an error then the packet is dropped as shown at block 170.

Thus, in one embodiment the input port 24, 26, 28 identifies the grant code “10” (error) in the grant code field 72 as a refusal of the request it submitted to the arbiter 36. However, if the grant code field 72 includes the code “01” (good), the input port 24 interprets this as an authorization to communicate its data packet across the crossbar 22 when the grant sequence number included in the grant sequence number field 78 is current. It is to be appreciated that the actual codes may differ from embodiment to embodiment and are merely provided by way of example in FIG. 5.

When a good grant code is received, the grant sequence number and the current pre-fetch sequence number of the particular target output port 24 are compared (see decision block 172). The comparison is repeated (see line 174) until the grant sequence number and the current pre-fetch sequence number match whereupon the pre-fetch buffer 116 (see FIG. 6) is then filled (see block 176). As shown at block 177, the pre-fetch sequence counter 142-156 associated with the particular output port 24 in then incremented. The pre-fetch sequence number may be incremented while the pre-fetch buffer is filled. In the embodiment depicted in the drawings, the reference pre-fetch incrementer 121 (see FIG. 6) increments a corresponding reference transmit counter (see FIGS. 7 and 8) in each output port 24, 26, 28 and the arbiter 36 via an associated outgoing increment line 119.0 to 119.9. The next step is then to determine when the data packet in the pre-fetch buffer can be transmitted.

In order to determine when the grant may be executed, and thus the data packet can be transmitted, the grant sequence number is compared with the current transmit sequence number of the particular output port 24 (see block 178). This comparison is performed until there is a match (see line 180) whereupon the data packet is transferred to the particular output port 24 (see block 182). Thereafter, as shown at block 184, the particular transmit sequence counter 126 to 140 associated with the particular output port 24, 26, 28 in then incremented as herein described. In the embodiment depicted in the drawings, the reference transmit incrementer 110 (see FIG. 6) increments a corresponding reference transmit counter (see FIGS. 7 and 8) in each output port 24, 26, 28 and the arbiter 36 via an associated outgoing increment line 118.0 to 118.9.

It will be appreciated that the various procedures or functions executed by the method 150 may be executed simultaneously, for example, the monitoring of the transmit sequence number and the pre-fetch sequence number for an associated port 24 may be preformed repetitively and independently of the function of processing a grant.

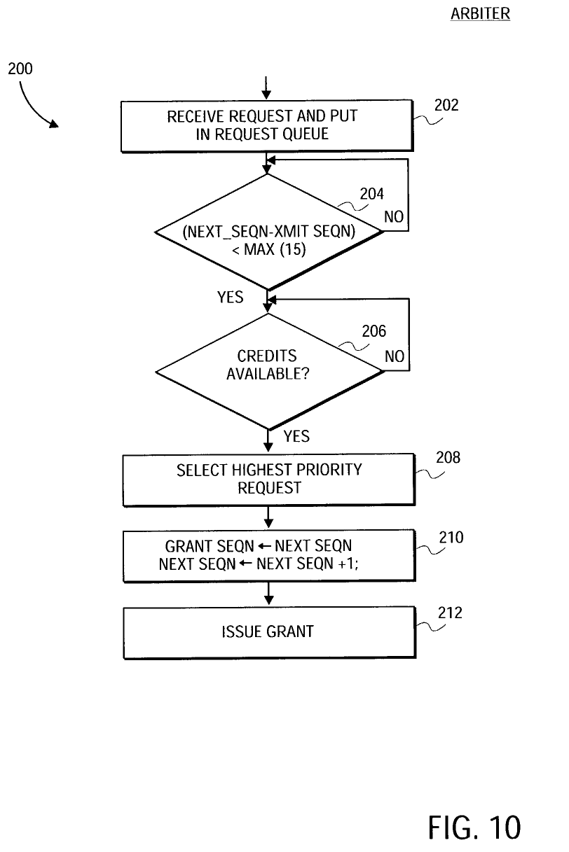

Referring in particular to FIG. 10 of the drawings, reference numeral 200 generally indicates an exemplary method, in accordance with an aspect of the invention, of managing grants in an arbiter. The method 200 provides another exemplary embodiment of the functionality shown in blocks 152 to 160 of FIG. 9A. In the method 200, the arbiter 36, as shown at block 202, receives a request from any one of the ports 24, 26, 28 to communicate a packet from the requesting port 24 to a destination output port 24. Prior to issuing a grant 70, the arbiter 36 checks a number of outstanding grants 70 that have already been issued for packets to be sent to the particular destination or output port 24. In particular, the transmit sequence number (the sequence number of the grant currently being executed) is subtracted from the next sequence number. If this difference is not less than 15, and there are thus 15 outstanding grants, the arbiter 36 waits until the number of outstanding grants is less than 15 (see decision block 204). If, however, there are less than 15 outstanding grants, the arbiter 36 then at decision block 206 checks to see if there are any credits available. When a credit becomes available, it is allocated to a request with the highest priority as shown at block 208. Thereafter, at block 210, the grant sequence number is incremented and the grant is issued (see block 212).

The maximum number of outstanding grants for a particular output port may be limited by the number of bits used to represent the sequence number. It is however to be appreciated that other unrelated factors may also limit the number of outstanding grants. In one embodiment, four bits are used to represent the sequence numbers. In general, the maximum number of outstanding grants equals 2ⁿ−1 where n is the number of bits used to represent the sequence number. When n equals 4, the maximum number of outstanding grants is 15.

The arbiter 36 may monitor the execution of grants 70 via lines 216.0 to 216.9 (see FIG. 7). In certain embodiments, the arbiter 36 may thus also include, for each particular port 24, an outstanding grant count register 218 (see FIG. 4) that is incremented and decremented as grants 70 are issued by the arbiter 36 and executed by the ports 24. Alternatively, in certain embodiments, the number of outstanding grants can be computed by subtracting the current transmit sequence number from the next grant sequence number, module 2ⁿ.

Thus, as described above, packets destined for a particular output port (e.g. output port 01) from the other ports 24 (ports 00 and 02 to 09) are sent in a sequence defined by the grant sequence numbers.

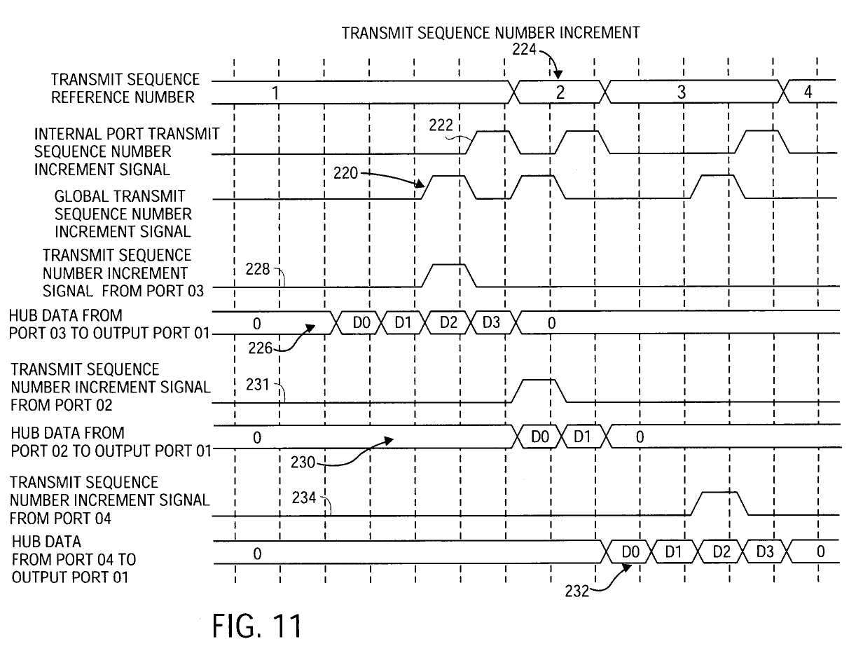

FIG. 11 shows exemplary timing signals of the datapath 20. While a particular port 24 is transmitting its packet across the crossbar 22, and thus its associated grant 70 is being executed, the reference transmit counter incrementer 110 (see FIG. 6) associated with the particular input port 24 from which the packet has been sent, provides a high transition as shown at 228 in FIG. 11. The high transition at 220 is provided on the increment grid 122 (see FIG. 7) via outgoing increment lines 118.0 to 118.9 (see FIG. 6). When the high transition 220 is received by each port 24 on its associated incoming increment line 120.0 to 120.9 (see FIG. 6) an internal increment transition 222 is generated on the next clock cycle by the counter incrementer component 124 (see FIG. 8). The counter incrementer component 124, in turn, then increments the appropriate reference transmit sequence register 126 to 140 as shown at 224 thereby incrementing the reference transmit sequence number.

In addition to the generic discussion above, FIG. 11 also provides an example of specific timing signals when packets in three different ports communicate a packet to a destination port 24 identified in the grant 70. In this example, assume that ports 02, 03 and 04 have packets for communication to a destination port 01. Further, assume that the arbiter 36 has allocated, for example, a grant sequence number 01 to the grant 70 sent to port 03, a grant sequence number 02 to the grant 70 sent to port 02 and a grant sequence number 03 to the grant 70 sent to port 04. Accordingly, the sequence in which the ports 02, 03 and 04 are to communicate their packet to the destination or output port 01 is, firstly, the packet from port 03, secondly, the packet from port 02 and, thirdly, the packet from port 04. When port 03 identifies that the reference transmit sequence number stored internally is equal to the grant sequence number issued to its grant 70, it communicates its packet across the crossbar 22 as shown at 226. However, prior to completion of the transmission of the packet, port 03 on its associated outgoing increment line 118.1 provides a increment signal 228 so that the reference transmit sequence number associated with destination or output port 01, in each of the ports 24, is incremented to 02. At this point in time, port 02 then identifies that the reference transmit sequence number now equals the grant sequence number of its grant 70 for the packet which it is to communicate to the destination port 01 and, accordingly, the port 02 commences communication of the packet as shown at 230. Once again, prior to completion of the communication of the packet, the port 02 then increments the reference transmit sequence number in each port 24 with the increment signal 231 in a similar fashion to that described above. The reference transmit sequence number in each port 24 is thus incremented to 03 and, accordingly, port 04 then identifies that the next grant in its queue has a grant sequence number that matches the reference transmit sequence number and thus communicates its packet across the crossbar 22, as shown at 232. Prior to completion of the transmission of the packet, port 04 provides an increment signal 234 to increment the transmit sequence reference count in all ports 24. It is to be appreciated that the above example relates to the communication of the data from three exemplary ports 02, 03, and 04 to a single output port 01. However, the methodology applies to the communication of any packets between the ports 24, 26, 28 that are connected to the crossbar 22.

Thus, in one embodiment, by using the reference transmit sequence numbers wherein each sequence number is associated with a particular port 24 when operating as an output device, a next data packet for transmission to the particular output port may be communicated across the crossbar 22 immediately after the preceding packet has been communicated thereby reducing latency and increasing utilization within the datapath 20.

In certain embodiments, in order to ensure that a packet for transmission across the datapath 20 may be transmitted by a particular port 24 as quickly as possible, each port 24 is provided with the pre-fetch functionality. In particular, in certain embodiments, the pre-fetch functionality substantially resembles the transmission sequence functionality described above except that, instead of timing the communication of a packet from the data transmission module 106 to the crossbar 22 using reference transmit sequence numbers, the pre-fetch functionality uses reference pre-fetch sequence numbers provided at each port 24.

In particular, the pre-fetch functionally, in an anticipatory fashion, fetches the particular packet from the input buffer 58 and loads it into the pre-fetch buffer 116 so that, when the particular grant 70 is executed in accordance with the grant sequence numbers described above, the communication of the data packet onto the crossbar 22 is facilitated. In certain embodiments, the pre-fetch functionality may avoid transmission gaps between two packets sent from different input ports 24 to a particular output port 24.

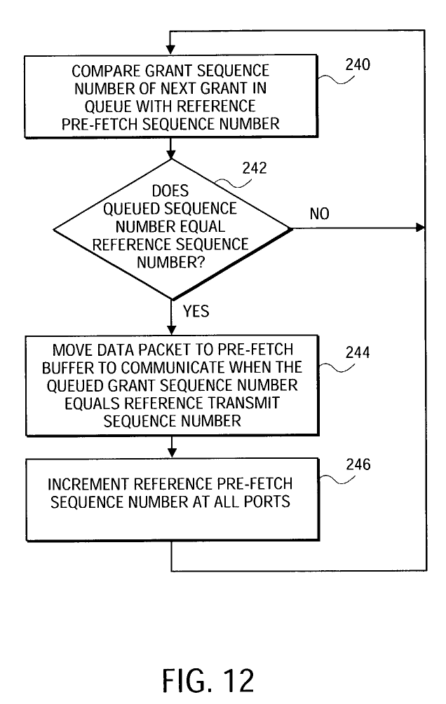

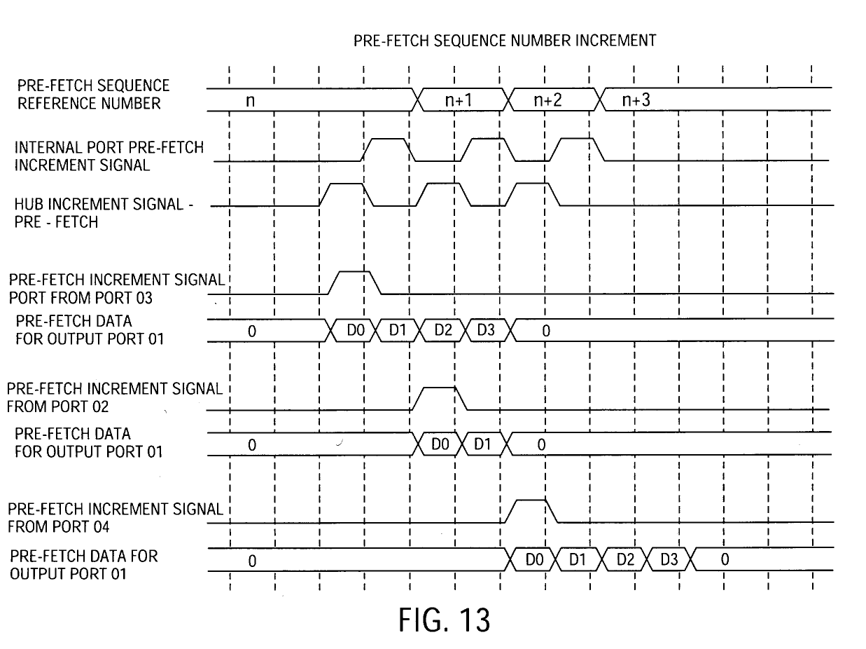

In one embodiment, packet pre-fetch begins when the grant sequence number of a particular grant 70 matches the current reference pre-fetch sequence number (see blocks 240 and 242 in FIG. 12). As shown at block 244, when the queued grant sequence number matches the pre-fetch reference sequence number, then the data packet is moved into the pre-fetch buffer 116. As in the case of the reference transmit sequence number, each port 24 maintains a local copy of the reference pre-fetch sequence number for every other port 24 in the datapath 20 and, accordingly, the pre-fetch counters 142 to 156 (see FIG. 8) are provided. Further, the timing signals for the pre-fetch functionality are shown in FIG. 13. In one embodiment, the pre-fetch sequence numbers are incremented at the start of a pre-fetch operation. Pre-fetch operations may overlap but are initiated in sequence to reduce the likelihood of a deadlock situation. In order to increment the reference pre-fetch sequence number for each port 24 at each port 24, the increment grid 122 of FIG. 7 is duplicated for the pre-fetch functionality. Once a packet associated with a particular grant 70 to be sent in accordance with the grant sequence numbers, has been communicated to the pre-fetch buffer 116, the associated pre-fetch counter is incremented (see block 246 in FIG. 12) so that any other port 24 which is to communicate a packet to the particular output port 24, may then pre-fetch the packet to be sent based on the grant sequence number associated with the particular packet.

The grant sequence number may define virtual output port grant queues wherein the queuing order is defined by a grant sequence number assigned to each grant 70. In certain embodiments, there is one virtual output port grant queue per physical output port (e.g. InfiniBand Port). In these embodiments, there are no physical output port queues. Thus, the grants may either be in an input port grant queue 102 or in the grant and pre-fetch controller 106 during processing.

In certain embodiments, the grant sequence numbers are n-bit binary values, which are incremented modulo 21. In one embodiment of the invention, n equals 4 and, accordingly, each output port 24 can have up to fifteen (2ⁿ−1) outstanding grants. Each output port 24 may have a current pre-fetch sequence number, a current transmit sequence number and a next sequence number. The current pre-fetch sequence number is the grant sequence number of the grant 70 that has permission to begin pre-fetching its associated packet from the input buffer 58 at the present time. The current transmit sequence number may be the grant sequence number of the grant 70 authorized to transmit or is actually transmitting at the present time. The next sequence number may then be used for the next grant sequence number.

The packet pre-fetch may ideally avoid transmission gaps between two packets going to the same output port 24. The pre-fetch functionality may compensate for mismatches between when an output port is ready for the next packet and an input buffer's read interleaving pattern. Packet pre-fetch can occur whenever an input buffer 58 interleave slot has been assigned, but transmission cannot begin because the grant sequence number of the grant 70 does not match the current transmit sequence number of the output port 24. The current transmit sequence number of output port 24 can increment at any time during the input buffer interleave rotation. If reading has not begun before the transmit sequence number increment signal is detected, there may be a gap between successive packets. The size of the gap may depend upon when the increment occurred in a rotation cycle.

Note also that embodiments of the present description may be implemented not only within a physical circuit (e.g., on semiconductor chip) but also within machine-readable media. For example, the circuits and designs discussed above may be stored upon and/or embedded within machine-readable media associated with a design tool used for designing semiconductor devices. Examples include a netlist formatted in the VHSIC Hardware Description Language (VHDL) language, Verilog language or SPICE language. Some netlist examples include: a behavioral level netlist, a register transfer level (RTL) netlist, a gate level netlist and a transistor level netlist. Machine-readable media also include media having layout information such as a GDS-II file. Furthermore, netlist files or other machine-readable media for semiconductor chip design may be used in a simulation environment to perform the methods of the teachings described above.

Thus, it is also to be understood that embodiments of this invention may be used as or to support a software program executed upon some form of processing core (such as the CPU of a computer) or otherwise implemented or realized upon or within a machine-readable medium. A machine-readable medium includes any mechanism for storing or transmitting information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

Thus, a method and system to communicate data between a plurality of interconnect devices have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method of communicating data between a plurality of interconnect devices, the method including:
allocating a sequence number associated with each grant authorizing a source interconnect device to communicate the data to a destination interconnect device;
comparing the sequence number of a queued grant with a reference sequence number; and
communicating the data in response to the comparison.

2. The method of claim 1, wherein the sequence number is a grant sequence number and the data is in the form of a data packet, the method including:
allocating a grant sequence number to each grant, the grant sequence number defining a sequence in which each grant is to be executed;
comparing the grant sequence number of a queued grant with a reference transmit sequence number; and
executing the grant in response to the comparison thereby to communicate the data.

3. The method of claim 2, which includes comparing at each interconnect device the grant sequence number of the next queued grant with the reference transmit sequence number that identifies the grant sequence number of the next grant to be executed.

4. The method of claim 3, which includes allocating at an arbiter a sequence of grant sequence numbers for each particular interconnect device, the grant sequence numbers being uniquely associated with each particular interconnect device and defining the order in which other interconnect devices communicate the data packet to the particular interconnect device.

5. The method of claim 4, which includes incrementing the reference transmit sequence number associated with the particular interconnect device at all other interconnect devices when the data packet has been communicated to the particular interconnect device.

6. The method of claim 4, which includes refraining from issuing further grant sequence numbers when a predetermined maximum number of grants remain unexecuted.

7. The method of claim 2, wherein the grant sequence numbers and the transmit sequence numbers are n-bit binary values.

8. The method of claim 2, wherein the interconnect devices are input/output ports forming part of a switch, the method including communicating the data packets through the switch when executing the grant.

9. The method of claim 1, wherein the sequence number is a grant sequence number and the data is in the form of a data packet, the method including:
allocating a grant sequence number to each grant, the grant sequence number defining a sequence in which the data packet associated with each grant is to be moved into a pre-fetch buffer;
comparing the grant sequence number of a queued grant with a reference pre-fetch sequence number; and
moving the data packet into the pre-fetch buffer in response to the comparison.

10. The method of claim 9, which includes comparing at each interconnect device the grant sequence number of the next queued grant with the reference pre-fetch sequence number that identifies the pre-fetch sequence number of a grant associated with the next data packet to be communicated from the interconnect device.

11. The method of claim 10, which includes allocating at an arbiter a sequence of grant sequence numbers for each particular interconnect device, the grant sequence numbers being uniquely associated with each particular interconnect device and defining the order in which data packets are moved into the pre-fetch buffer for communication dependent upon the grant sequence number.

12. The method of claim 11, which includes incrementing the reference pre-fetch sequence number associated with the particular interconnect device at all other interconnect devices when the data packet has been moved to the pre-fetch buffer.

13. The method of claim 9, wherein the grant sequence numbers and the pre-fetch sequence numbers are n-bit binary values.

14. A method of controlling the communication of data from an interconnect device, the method including:
receiving a grant authorizing the communication of the data;
extracting a grant sequence number from the grant;
comparing the grant sequence number with a reference transmit sequence number; and
communicating the data in response to the comparison.

15. The method of claim 14, wherein the data is in the form of data packets and the method includes comparing at the interconnect device the grant sequence number of the next queued grant with the reference transmit sequence number that identifies the grant sequence number of the next grant to be executed.

16. The method of claim 15, which includes storing at the interconnect device a reference transmit sequence number for each of a plurality of associated interconnect devices, each reference transmit sequence number being uniquely associated with a particular associated interconnect device and defining the order in which the interconnect device communicates data packets to the associated interconnect devices.

17. The method of claim 16, which includes communicating a reference transmit increment signal to the associated interconnect devices while the data packet is communicated by the particular interconnect device.

18. The method of claim 17, which includes incrementing the reference transmit sequence number for each of the plurality of associated interconnect devices in response to the reference transmit increment signals.

19. The method of claim 14, wherein the grant sequence numbers are n-bit binary values.

20. The method of claim 14, wherein the interconnect device is an input/output port forming part of a switch.

21. The method of claim 14, which includes:
receiving a grant sequence number associated with a grant authorizing the interconnect device to communicate a data packet to one of associated interconnect devices, the grant sequence number defining a sequence in which a data packet associated with each grant is to be moved into a pre-fetch buffer of the interconnect device;
comparing the grant sequence number of the grant with a reference pre-fetch sequence number; and
moving the data packet into the pre-fetch buffer in response to the comparison.

22. The method of claim 21, which includes comparing at the interconnect device the grant sequence number of the next queued grant with the reference pre-fetch sequence number that identifies the grant sequence number of the next grant to be executed.

23. The method of claim 22, in which an arbiter allocates a sequence of grant sequence numbers for all interconnect devices, the grant sequence numbers being uniquely associated with each particular interconnect device and defining the order in which data packets are moved into the pre-fetch buffer for communication dependent upon the grant sequence number.

24. The method of claim 23, which includes communicating a reference pre-fetch increment signal to the associated interconnect devices when the data packet has been moved into the pre-fetch buffer.

25. The method of claim 23, which includes incrementing the reference pre-fetch sequence number for each of the plurality of associated interconnect devices in response to the reference pre-fetch increment signals.

26. The method of claim 21, wherein the grant sequence numbers and pre-fetch sequence numbers are n-bit binary values.

27. A method of managing the execution of grants issued to a plurality of interconnect devices, the method including:
receiving a grant request from an interconnect device to communicate data to a destination interface device;
selectively allocating a grant sequence number to the grant, the grant sequence number defining when the grant is to be executed; and
communicating the grant sequence number to the interconnect device.

28. The method of claim 27, wherein the grant sequence number is included within the grant communicated to the interconnect device.

29. The method of claim 27, which includes allocating at an arbiter a sequence of grant sequence numbers for each particular interconnect device, the grant sequence numbers being uniquely associated with each particular interconnect device when functioning as a destination interconnect device and defining the order in which other interconnect devices communicate data in the form of data packets to the destination interconnect device.

30. The method of claim 27, which includes refraining from issuing further grant sequence numbers when a predetermined maximum number of grants remain unexecuted.

31. The method of claim 30, which includes monitoring when a grant is executed and decrementing the outstanding grants counter in response to the execution of a grant.

32. The method of claim 27, wherein the grant sequence numbers are n-bit binary values.

33. A machine-readable medium embodying a sequence of instructions that, when executed by a machine, cause the machine to execute a method of communicating data between a plurality of interconnect devices, method including:
allocating a sequence number associated with each grant authorizing a source interconnect device to communicate the data to a destination interconnect device;
comparing the sequence number of a queued grant with a reference sequence number; and
communicating the data in response to the comparison.

34. The machine-readable medium of claim 33, wherein the sequence number is a grant sequence number and the data is in the form of a data packet, the method including:
allocating a grant sequence number to each grant, the grant sequence number defining a sequence in which each grant is to be executed;
comparing the grant sequence number of a queued grant with a reference transmit sequence number; and
executing the grant in response to the comparison thereby to communicate the data.

35. The machine-readable medium of claim 34, wherein the method includes comparing at each interconnect device the grant sequence number of the next queued grant with the reference transmit sequence number that identifies the grant sequence number of the next grant to be executed.

36. The machine-readable medium of claim 35, wherein the method includes:
allocating a grant sequence number to each grant, the grant sequence number defining a sequence in which the data packet associated with each grant is to be moved into a pre-fetch buffer;
comparing the grant sequence number of a queued grant with a reference pre-fetch sequence number; and
moving the data packet into the pre-fetch buffer in response to the comparison.

37. The machine-readable medium of claim 36, wherein the method includes comparing at each interconnect device the grant sequence number of the next queued grant with the reference pre-fetch sequence number that identifies the pre-fetch sequence number of a grant associated with the next data packet to be communicated from the interconnect device.

38. A machine-readable medium embodying a sequence of instructions that, when executed by a machine, cause the machine to execute a method of controlling the communication of data from an interconnect device, the method including:
receiving a grant authorizing the communication of the data;
extracting a grant sequence number from the grant;
comparing the grant sequence number with a reference transmit sequence number; and
communicating the data in response to the comparison.

39. The machine-readable medium of claim 38 wherein the data is in the form of data packets and the method includes comparing at the interconnect device the grant sequence number of the next queued grant with the reference transmit sequence number that identifies the grant sequence number of the next grant to be executed.

40. The machine-readable medium of claim 38, which includes storing at the interconnect device a reference transmit sequence number for each of a plurality of associated interconnect devices, each reference transmit sequence number being uniquely associated with a particular associated interconnect device and defining the order in which the interconnect device communicates data packets to the associated interconnect devices.

41. The machine-readable medium of claim 40, which includes communicating a reference transmit increment signal to the associated interconnect devices while the data packet is communicated by the particular interconnect device.

42. The machine-readable medium of claim 38, in which the method includes:
receiving a grant sequence number associated with a grant authorizing the interconnect device to communicate a data packet to one of associated interconnect devices, the grant sequence number defining a sequence in which a data packet associated with each grant is to be moved into a pre-fetch buffer of the interconnect device;
comparing the grant sequence number of the grant with a reference pre-fetch sequence number; and
moving the data packet into the pre-fetch buffer in response to the comparison.

43. The machine-readable medium of claim 42, in which the method includes comparing at the interconnect device the grant sequence number of the next queued grant with the reference pre-fetch sequence number that identifies the grant sequence number of the next grant to be executed.

44. The machine-readable medium of claim 43, in which the method includes communicating a reference pre-fetch increment signal to the associated interconnect devices when the data packet has been moved into the pre-fetch buffer.

45. The machine-readable medium of claim 43, in which the method includes incrementing the reference pre-fetch sequence number for each of the plurality of associated interconnect devices in response to an associated pre-fetch input signal.

46. A machine-readable medium embodying a sequence of instructions that, when executed by a machine, cause the machine to execute a method of managing the execution of grants issued to a plurality of interconnect devices, the method including:
receiving a grant request from an interconnect device to communicate data to a destination interface device;
selectively allocating a grant sequence number to the grant that defines when the grant is to be executed; and
communicating the grant sequence number to the interconnect device.

47. The machine-readable medium of claim 46, wherein the grant sequence number is included within the grant communicated to the interconnect device.

48. The machine-readable medium of claim 46, in which the method includes allocating at an arbiter a sequence of grant sequence numbers for each particular interconnect device, the grant sequence numbers being uniquely associated with each particular interconnect device when functioning as a destination interconnect device and defining the order in which other interconnect devices communicate data in the form of data packets to the destination interconnect device.

49. The machine-readable medium of claim 46, in which the method includes refraining from issuing further grant sequence numbers when a predetermined maximum number of grants remain unexecuted.

50. A system for communicating data between a plurality of interconnect devices, system including:
an arbiter to allocate a sequence number associated with each grant authorizing a source interconnect device to communicate the data to a destination interconnect device;
a comparator to compare the sequence number of a queued grant with a reference sequence number; and
a data transmission module to communicate the data in response to the comparison.

51. The system of claim 50, wherein the sequence number is a grant sequence number and the data is in the form of a data packet, and wherein:
the arbiter allocates a grant sequence number to each grant, the grant sequence number defining a sequence in which each grant is to be executed;
the comparator compares the grant sequence number of a queued grant with a reference transmit sequence number; and
the data transmission module executes the grant in response to the comparison thereby to communicate the data.

52. The system of claim 51, wherein the comparator compares at each interconnect device the grant sequence number of the next queued grant with the reference transmit sequence number that identifies the grant sequence number of the next grant to be executed.

53. The system of claim 50, wherein the sequence number is a grant sequence number and the data is in the form of a data packet, and wherein:
the arbiter allocates a grant sequence number to each grant, the grant sequence number defining a sequence in which the data packet associated with each grant is to be moved into a pre-fetch buffer;
the comparator compares the grant sequence number of a queued grant with a reference pre-fetch sequence number; and
the data transmission module moves the data packet into the pre-fetch buffer in response to the comparison.

54. The system of claim 53, wherein the comparator compares at each interconnect device the grant sequence number of the next queued grant with the reference pre-fetch sequence number that identifies the grant sequence number of a grant associated with the next data packet to be communicated from the interconnect device.

55. An interconnect device, which includes:
a grant module to receive a grant authorizing the communication of data received by the interconnect to an associated interconnect device;
a processor to extract a grant sequence number from the grant and to compare the grant sequence number with a reference transmit sequence number; and
a data transmission module to communicate the data in response to the comparison.

56. The interconnect device of claim 55, wherein the data is in the form of data packets and the processor compares at the interconnect device the grant sequence number of the next queued grant with the reference transmit sequence number that identifies the grant sequence number of the next grant to be executed.

57. The interconnect device of claim 56, which includes a buffer to store a reference transmit sequence number for each of a plurality of associated interconnect devices, each reference transmit sequence number being uniquely associated with a particular associated interconnect device and defining the order in which the interconnect device communicates data packets to the associated interconnect devices.

58. The interconnect device of claim 57, which communicates a reference transmit increment signal to the associated interconnect devices while the data packet is communicated by the particular interconnect device.

59. The interconnect device of claim 57, which includes memory for storing a grant sequence number associated with a grant authorizing the interconnect device to communicate a data packet to one of associated interconnect devices, the grant sequence number defining a sequence in which a data packet associated with each grant is to be moved into a pre-fetch buffer of the interconnect device, the processor comparing the grant sequence number of the grant with a reference pre-fetch sequence number and moving the data packet into the pre-fetch buffer in response to the comparison.

60. The interconnect device of claim 59, in which the processor compares the grant sequence number of the next queued grant with the reference pre-fetch sequence number that identifies the grant sequence number of the next grant to be executed.

61. The interconnect device of claim 60, in which the data transmission module communicates a reference pre-fetch increment signal to the associated interconnect devices when the data packet has been moved into the pre-fetch buffer.

62. The interconnect of claim 60, in which the processor increments the reference pre-fetch sequence number for each of the plurality of associated interconnect devices in response to an associated pre-fetch input signal.

63. An arbiter for managing the execution of grants issued to a plurality of interconnect devices, the arbiter including a grant allocator:
to receive a grant request from an interconnect device to communicate data to a destination interface device;
to selectively allocate a grant sequence number to the grant that defines when the grant is to be executed; and
to communicate the grant sequence number to the interconnect device.

64. The arbiter of claim 63, wherein the grant sequence number is included within the grant communicated to the interconnect device.

65. The arbiter of claim 63, in which the allocator allocates a sequence of grant sequence numbers for each particular interconnect device, the grant sequence numbers being uniquely associated with each particular interconnect device when functioning as a destination interconnect device and defining the order in which other interconnect devices communicate data in the form of data packets to the destination interconnect device.

66. The arbiter of claim 65, in which the allocator refrains from issuing further grant sequence numbers when a predetermined maximum number of grants remain unexecuted.

67. A system for communicating data between a plurality of interconnect devices, system including:
means for allocating a sequence number associated with each grant authorizing a source interconnect device to communicate the data to a destination interconnect device;
means for comparing the sequence number of a queued grant with a reference sequence number; and
means for communicating the data in response to the comparison.
